(19) United States
(12) Patent Application Publication
(10) Pub. No.: US 2022/0144667 A1
(43) Pub. Date: May 12, 2022

(54) WATER RECYCLING SYSTEM

(71) Applicant: SAFE FOODS CORPORATION, North Little Rock, AR (US)

(72) Inventors: Tim Yeaman, Russellville, AR (US); Ryan Foley, Russellville, AR (US)

(21) Appl. No.: 17/437,354

(22) PCT Filed: Mar. 19, 2020
(86) PCT No.: PCT/US2020/023511

§ 371 Date: Sep. 8, 2021

Related U.S. Application Data
(60) Provisional application No. 62/821,530, filed on Mar. 21, 2019.

(51) Int. Cl. C02F 1/00; C02F 1/50; B01D 33/50; B01D 29/11

(52) U.S. Cl. CPC C02F 1/008; C02F 1/001; C02F 1/50; B01D 33/50; B01D 29/11; B01D 2201/081; C02F 2303/16; C02F 2209/42; C02F 2209/44; C02F 2303/04; C02F 2209/40

(57) ABSTRACT

A water recycling system includes a tank configured to hold a washing liquid, a washing operation in fluid communication with the tank, wherein the washing operation utilizes the washing liquid, a filtering assembly positioned between the tank and the washing operation configured to filter particulate matter from the washing liquid, a supply line connected to the tank and configured to supply fresh water to the tank, a supply line meter associated with the supply line, the supply line meter configured to measure a volume of water through the supply line to the tank, and a throughput meter associated with the washing operation, the throughput meter configured to measure a volume of the washing liquid into or out of the washing operation.

### FIELD OF THE DISCLOSURE

The present disclosure is related to a water recycling system. In particular, the present disclosure is related to a monitored water recycling system and a method of determining and providing real time water savings and/or water usage information.

### BRIEF DESCRIPTION OF THE DRAWINGS

FIG. 1 is a diagrammatic view of a water recycling system according to an embodiment of the present disclosure.

FIG. 2 is a diagrammatic illustration of a monitoring system to be used with the water recycling system shown in FIG. 1.

FIG. 3 is a diagrammatic illustration of a control unit to be used with the water recycling system shown in FIG. 1.

FIG. 4 is an illustration of a display according to an embodiment of the present disclosure.

FIG. 5 is an illustration of a display according to an embodiment of the present disclosure.

FIG. 6 is a flow chart illustration of a method of monitoring water savings according to an embodiment of the present disclosure.

FIG. 7 is a flow chart illustration of a method of monitoring a water recycling system according to an embodiment of the present disclosure.

### DETAILED DESCRIPTION

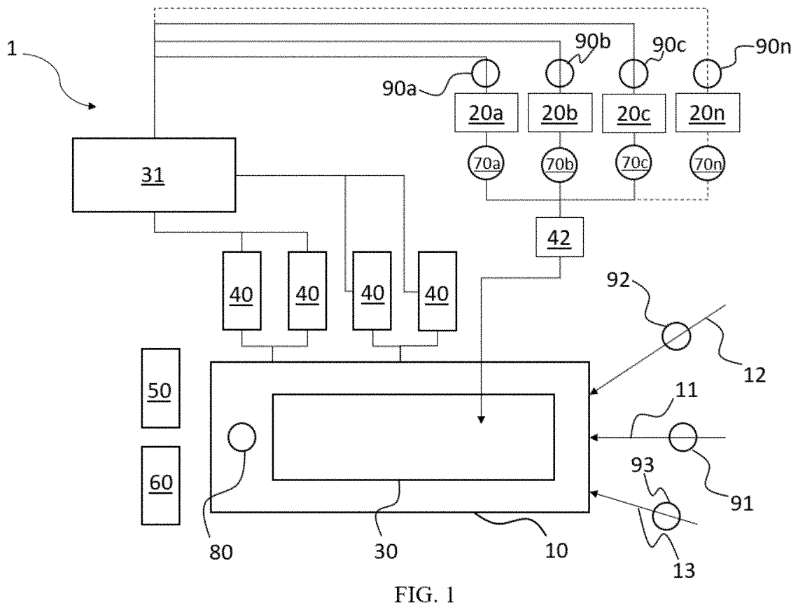

As shown in FIG. 1, the water recycling system 1 includes a tank 10 that stores a washing solution to be used for a washing operation. The washing solution includes fresh water supplied by incoming water line 11. Optional additives, such as antimicrobial agents, may be supplied by additional lines, such as chemical injection line 13. An example of an antimicrobial agent useful in the present disclosure is peroxyacetic acid (PAA).

The washing solution is transported from the tank 10 by at least one pump 40. Additional pumps 40 may be provided depending on the particular operating requirements. For example, 1 to 10 pumps 40 may be provided. The pumps 40 transport the washing solution from the tank 10 to an operation 20a, 20b, 20c . . . 20n. The pumps 40 are not particularly limited and may be, for example, an air diaphragm pump, an electric pump, or the like.

The operations 20a, 20b, 20c . . . 20n are not particularly limited and may be any operation wherein filtering and recycling is required or desired. Although operations 20a, 20b, 20c . . . 20n are shown, the system 1 may include a single operation, 2 operations, 3 operations, or 4 or more operations. For instance, the operations 20a, 20b, 20c . . . 20n may include a washing station, for example, one or more inside outside bird washers (IOBW). In some embodiments, the operations 20a, 20b, 20c . . . 20n may include a chiller system or a dip tank. The flow rate and pressure employed in the operations 20a, 20b, 20c . . . 20n is not particularly limited and may be specified based on particular operating requirements.

After the washing solution has been utilized in the operations 20a, 20b, 20c . . . 20n, the spent washing solution flows through drains 70a, 70b, 70c . . . 70n to at least one filtering assembly 30 to recover a recycled solution. To facilitate flow from the drains 70a, 70b, 70c . . . 70n to the filtering assembly 30, a pump 42 may be employed. The pump 42 is not particularly limited and may be, for example, an air diaphragm pump, an electric pump, or the like. In one or more embodiments, a plurality of pumps 42 may be employed. For example, a separate pump 42 may be associated with each of 20a, 20b, 20c . . . 20n. The recycled solution may be directed back into tank 10 (i.e., re-used as washing solution) or may be diverted to a secondary storage container (not shown) for alternative uses.

The filtering assembly 30 may include, for example, a rotary screen. In such cases, a spray bar line 12 may supply additional solution to the rotary screen (filtering assembly 30) in order to wash the rotary screen. The additional solution may include, for example, fresh water, a solution (e.g., an antimicrobial solution), or the recycled solution recovered from the filtering assembly 30. The rate of flow through the spray bar line 12 is not particularly limited, and may be, for example, from 0 gallon per minute (gpm) to 60 gpm, from 60 gpm to 100 gpm, from 100 to 160 gpm, from 1 gpm to 200 gpm, from 5 gpm to 100 gpm, or from 10 gpm to 50 gpm.

One or more secondary filtering assemblies 31 may be employed as needed throughout the system 1. The secondary filtering assembly 31 may, for example, include an inline filter, such as a bag filter, between the tank 10 and the operations 20a, 20b, 20c . . . 20n. Depending on operating requirements, the filtering assemblies 30, 31 may be configured to filter out particles greater than 1 mm, greater than 900 μm, greater than 800 μm, greater than 700 μm, greater than 600 μm, greater than 500 μm, greater than 400 μm, greater than 300 μm, greater than 200 μm, or greater than 100 μm. For instance, the filtering assembly 30 or 31 may include a mesh having pores of any of the foregoing sizes. If the washing solution includes large particles, spray nozzles (not shown) used throughout the system 1 (e.g., used to spray the rotary screen or used in the operation 20) may become clogged. Additionally, filters that are too fine may require more frequent maintenance. As such, the filtering assemblies 30, 31 and nozzle sizes may be appropriately adjusted to suit the operational needs.

In one or more embodiments, a volume of washing solution in the tank 10 is maintained at a constant level. This may be achieved by, for example, adjusting the amount of fresh water supplied by incoming water line 11. The rate of flow through the incoming water line 11 is not particularly limited, and may be, for example, from 0 gpm to 1000 gpm, from 10 gpm to 500 gpm, or 60 gpm to 250 gpm. The flow rate through incoming water line 11 may be constant or variable. For instance, if a known amount of liquid is lost through the washing operation, the flow rate may be adjusted appropriately to offset such loss. In some embodiments, the flow rate may be adjusted to overflow the tank 10 thereby refreshing the washing solution. Alternatively, the flow rate may be manually or automatically varied based on the observed volume in the tank 10. Optionally, the tank 10 may include a sensor 80, such as a transducer, in order to monitor the volume of washing solution therein. The sensor 80 may also measure other properties of the liquid in the tank 10, such as the salinity, acidity, temperature, viscosity, and the like. The system 1 may include additional components as needed, for example, a high voltage panel 60 and a control panel 50.

The system 1 includes at least one meter to measure a flow rate or volume of solution within the system 1. In some embodiments, each inlet line includes a meter to provide a measurement of total volume or rate of liquid supplied to the system 1 (“supplied water volume/rate”). Namely, incoming water line 11 includes a meter 91 and, optionally, spray bar line 12 and chemical injection line 13 include meters 92 and 93, respectively. In any embodiment, a plurality of incoming water lines 11, a plurality of spray bar lines 12, and/or a plurality of chemical injection lines 13 may be included in the system, each including meters 91, meters 92, and/or meters 93, respectively. Additionally, the system 1 may include at least one meter between the tank 10 and the operations 20a, 20b, 20c . . . 20n. For instance, meters 90a, 90b, 90c . . . 90n may be supplied either before or after each operation 20a, 20b, 20c . . . 20n to obtain a measurement of a total liquid volume or rate utilized in the system 1 (“used water volume/rate”). In some embodiments, meters 90a, 90b, 90c . . . 90n are provided between the tank 10 and the operations 20a, 20b, 20c . . . 20n, such as before the washing operation in order achieve an accurate measurement of used volume (or usage rate), as some volume of liquid is likely to be lost during the washing. In one or more embodiments, a single meter 90a may be used with a plurality of operations 20a, 20b, 20c . . . 20n. For example, the single meter 90a may measure the rate or volume of a liquid passing through a communal line which subsequently splits to supply liquid to the plurality of operations 20a, 20b, 20c . . . 20n. In one or more embodiments, the meters 90a, 90b, 90c . . . 90n may be provided within the operations 20a, 20b, 20c . . . 20n. The meters 90a, 90b, 90c . . . 90n relay the collected information to a processor, which can then calculate a water savings value by subtracting the supplied volume or rate from the used volume or rate, as discussed in detail below.

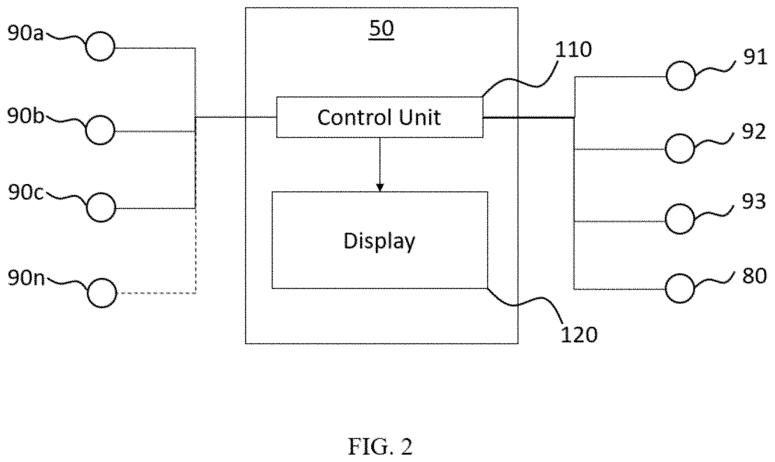

With reference to FIG. 2, in one or more embodiments, each of the meters 90a, 90b, 90c . . . 90n, 91, 92, and 93, and the sensor 80 may be connected to a control unit 110 of the control panel 50. The information from these meters and/or sensors may be used by the control unit 110 to control flow rates or pressures within the system, open or close valves, or calculate water usage and water savings values to be displayed on the display 120. For example, the water savings may be calculated by subtracting the measured “supplied water volume” from the measured “used water volume” or by subtracting the measured “supplied water rate” from the measured “used water rate.” As used herein, the terms “supplied water volume”, “used water volume”, “supplied water rate”, and “used water rate” may refer to a volume or rate of liquid including fresh water, a solution (e.g., an antimicrobial solution), and/or recycled solution.

In some embodiments, a plurality of instructions, or computer program(s), are stored on a non-transitory computer readable medium, the instructions or computer program(s) being accessible to, and executable by, one or more processors. In some embodiments, the one or more processors execute the plurality of instructions (or computer program(s)) to operate in whole or in part the above-described embodiments. In some embodiments, the one or more processors are part of the control unit 110, one or more other computing devices, or any combination thereof. In some embodiments, the non-transitory computer readable medium is part of the control unit 110, one or more other computing devices, or any combination thereof.

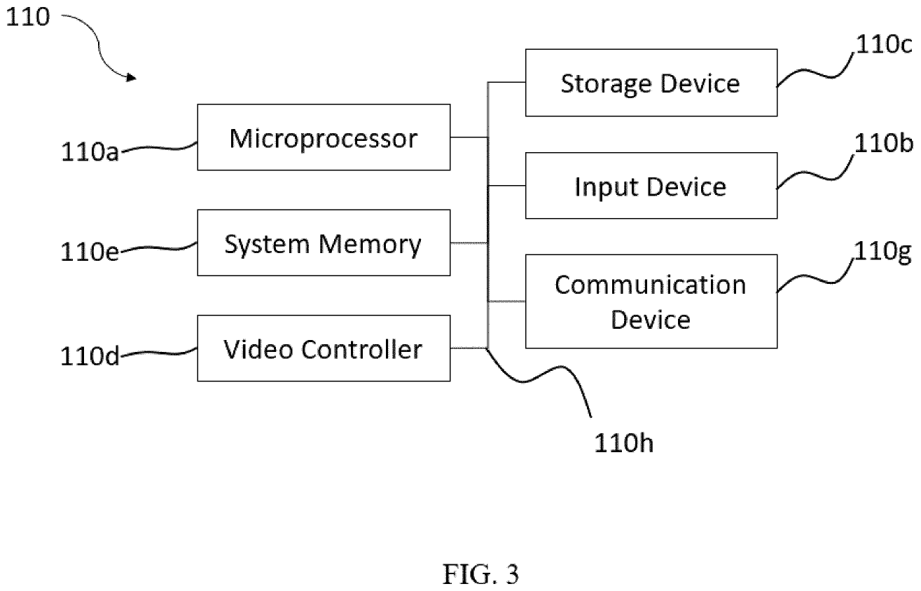

In an embodiment, as illustrated in FIG. 3, a control unit 110 for implementing one or more embodiments of the present disclosure is depicted. The control unit 110 includes a microprocessor 110a, an input device 110b, a storage device 110c, a video controller 110d, a system memory 110e, and a communication device 110g all interconnected by one or more buses 110h. In some embodiments, the storage device 110c may include a floppy drive, hard drive, CD-ROM, optical drive, any other form of storage device and/or any combination thereof. In some embodiments, the storage device 110c may include, and/or be capable of receiving, a floppy disk, CD-ROM, DVD-ROM, or any other form of computer-readable medium that may contain executable instructions. In some embodiments, the communication device 110g may include a modem, network card, or any other device to enable the computing device to communicate with other computing devices. In some embodiments, any computing device represents a plurality of interconnected (whether by intranet or Internet) computer systems, including without limitation, personal computers, mainframes, PDAs, smartphones and cell phones.

In some embodiments, one or more of the components of the system 1 include at least the control unit 110 and/or components thereof, and/or one or more computing devices that are substantially similar to the control unit 110 and/or components thereof. In some embodiments, one or more of the above-described components of the control unit 110 include respective pluralities of the same components.

In some embodiments, a computer system typically includes at least hardware capable of executing machine readable instructions, as well as the software for executing acts (typically machine-readable instructions) that produce a desired result. In some embodiments, a computer system may include hybrids of hardware and software, as well as computer sub-systems.

In some embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In some embodiments, hardware may include any physical device that is capable of storing machine-readable instructions, such as memory or other data storage devices. In some embodiments, other forms of hardware include hardware sub-systems, including transfer devices such as modems, modem cards, ports, and port cards, for example.

In some embodiments, software includes any machine code stored in any memory medium, such as RAM or ROM, and machine code stored on other devices (such as floppy disks, flash memory, or a CD ROM, for example). In some embodiments, software may include source or object code. In some embodiments, software encompasses any set of instructions capable of being executed on a computing device such as, for example, on a client machine or server.

In some embodiments, combinations of software and hardware could also be used for providing enhanced functionality and performance for certain embodiments of the present disclosure. In an embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In some embodiments, computer readable mediums include, for example, passive data storage, such as a random access memory (RAM) as well as semi-permanent data storage such as a compact disk read only memory (CD-ROM). One or more embodiments of the present disclosure may be embodied in the RAM of a computer to transform a standard computer into a new specific computing machine. In some embodiments, data structures are defined organizations of data that may enable an embodiment of the present disclosure. In an embodiment, a data structure may provide an organization of data, or an organization of executable code.

In some embodiments, any networks and/or one or more portions thereof, may be designed to work on any specific architecture. In an embodiment, one or more portions of any networks may be executed on a single computer, local area networks, client-server networks, wide area networks, Internets, hand-held and other portable and wireless devices and networks.

In some embodiments, a database may be any standard or proprietary database software. In some embodiments, the database may have fields, records, data, and other database elements that may be associated through database specific software. In some embodiments, data may be mapped. In some embodiments, mapping is the process of associating one data entry with another data entry. In an embodiment, the data contained in the location of a character file can be mapped to a field in a second table. In some embodiments, the physical location of the database is not limiting, and the database may be distributed. In an embodiment, the database may exist remotely from the server, and run on a separate platform. In an embodiment, the database may be accessible across the Internet. In some embodiments, more than one database may be implemented.

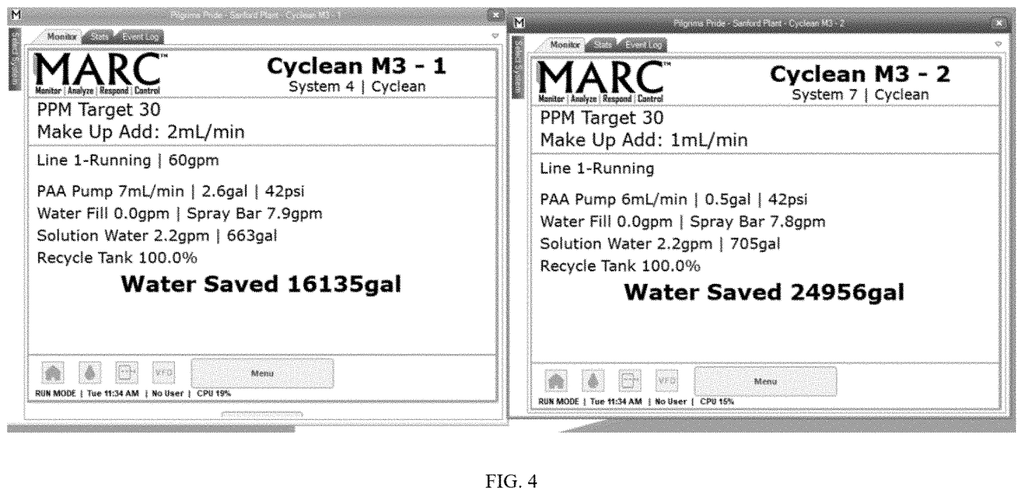

In one or more embodiments, the water savings value may be displayed in real time, for example, on the display 120 of control panel 50. As shown in FIG. 4, various parameters of the system 1 may be displayed, such as the calculated water savings and flow rates or volumes measured by one or more of the meters 90a, 90b, 90c . . . 90n. In one or more embodiments, multiple systems 1 may be in communication with a single control unit, such that the display 120 may show data corresponding to the multiple systems, as shown in FIG. 4.

In any embodiment, the control unit 110 may create an alert based on the measured flow rate or volume data, the sensor data, or any other data calculated by the control unit 110. For example, if any of the meters 90a, 90b, 90c . . . 90n, 91, 92, or 93 or sensor 80 reports data to the control unit 110 that exceeds or falls below a predetermined threshold, the control unit 110 may create an alert. In one or more embodiments, the alert may be audible, visual, or both, wherein a visual alert may be displayed on the display 120.

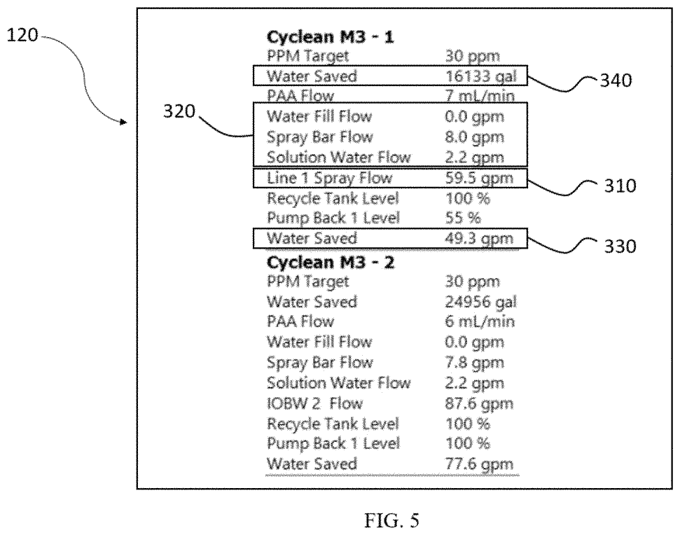

With reference to FIG. 5, the display 120 may include additional data such as the supplied water rate (a combination of the supply rates shown at 320), the used water rate 310, the water savings rate 330 (calculated by subtracting the supplied water rate 320 from the used water rate 310), and the total water saved 340 (calculate by multiplying water savings rate by time of running the system or by subtracting total water volume supplied from the total water volume used). According to the embodiment shown in FIG. 5, the display provides real time water savings data, including both the rate of savings and the total amount saved during a set period of operation.

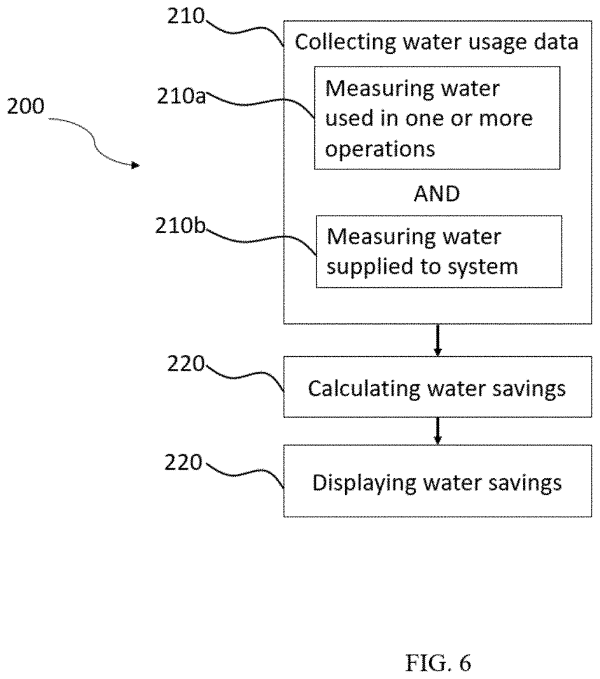

Referring to FIG. 6, a method 200 of monitoring a water recycling system is depicted. The method 200 includes a step 210 of collecting water usage data. Step 210 includes a step 210a of measuring water used in one or more operations and a step 210b of measuring water supplied to the system. The water used may be measured by one or more of the meters 90a, 90b, 90c . . . 90n. In one or more embodiments, a single operation 20a is included in the system 1 and step 210a includes measuring water usage from a single meter 90a. The water supplied may be measured by one or more of the meters 91, 92, and 93. In any embodiment, meters 91, 92, and/or 93 may be omitted and/or a plurality of meters 91, a plurality of meters 92, and/or a plurality of meters 93 may be utilized. In step 220, the water savings rate or volume is calculated. This calculation may be performed by the control unit 110 as described herein. The calculation may, for example, comprise subtracting the measured rate of water supplied from the measured rate of water used or subtracting the measured volume of water supplied from the measured volume of water used. In step 220, the calculated water savings is displayed. In step 220, for example, control unit 110 may transmit the calculated water savings data to the display 120. The data shown may include, for example, one or more of a water savings rate, a total water savings value, a water usage rate, a water usage volume, a water supply rate, a water supply volume, and the like.

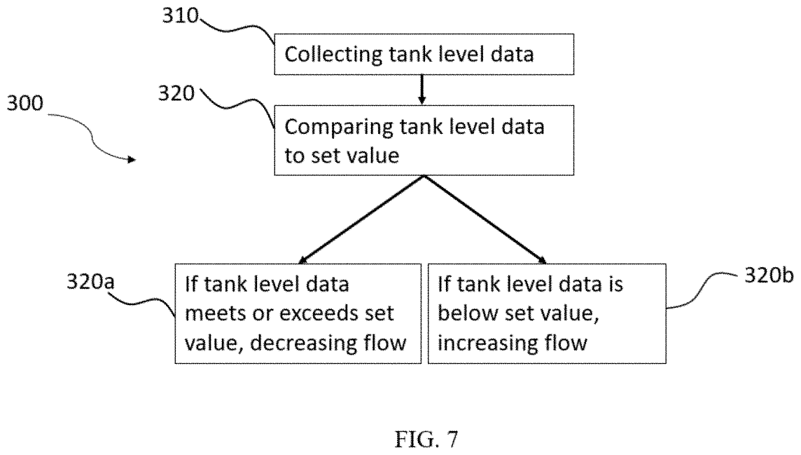

In one or more embodiments, as shown in FIG. 7, a method 300 may include a step 310 of collecting tank level data, which may include measuring the level of water in the tank 10 via the sensor 80. The method 300 may further include a step 320 of comparing the data from step 310 with a set value, wherein the set value may be a desired tank fill level (e.g., expressed as a percentage total of the volume of the tank 10). In step 320a, if the tank level is at or above the set value, flow through one or more of the supply lines (incoming water line 11, spray bar line 12, and/or chemical injection line 13) is decreased or ceased, for example, by closing a supply line valve. In step 320b, if the tank level is below the set value, flow though one or more of the supply lines is increased, for example, by opening a closed supply line valve.

In one or more embodiments, the set value may be greater than 100% such that the flow rate through the supply lines causes the tank 10 to constantly overflow, thereby refreshing the liquid within the system 1. In one or more embodiments, the tank 10 may include an overflow outlet (not shown) equipped with a meter configured to measure a flow rate out of the tank 10.

In any embodiment, the method may include triggering an alert, such as the alert described in detail above.

Food processing requires a significant amount of water. According to embodiments of the present disclosure, the system 1 can ensure that a food processing plant will be able to reduce the amount of water used for operation of the plant. By filtering and treating the washing solution, the system 1 may help a plant reduce costs without sacrificing food safety. The system 1 can be implemented in multiple locations throughout a plant, thereby providing flexibility and potential increased savings and product margins. The system 1 can also provide real time water savings such that reuse performance can be readily analyzed.

It is understood that variations may be made in the foregoing without departing from the scope of the present disclosure.

In some embodiments, the elements and teachings of the various embodiments may be combined in whole or in part in some or all of the embodiments. In addition, one or more of the elements and teachings of the various embodiments may be omitted, at least in part, and/or combined, at least in part, with one or more of the other elements and teachings of the various embodiments.

In some embodiments, while different steps, processes, and procedures are described as appearing as distinct acts, one or more of the steps, one or more of the processes, and/or one or more of the procedures may also be performed in different orders, simultaneously and/or sequentially. In some embodiments, the steps, processes and/or procedures may be merged into one or more steps, processes and/or procedures.

In some embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

In this specification, the word “comprising” is to be understood in its “open” sense, that is, in the sense of “including”, and thus not limited to its “closed” sense, that is in the sense of “consisting only of”. A corresponding meaning is to be attributed to the corresponding words “comprise”, “comprised” and “comprises” where they appear.

Although some embodiments have been described in detail above, the embodiments described are illustrative only and are not limiting, and those skilled in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

What is claimed is:

1. A water recycling system comprising:
a tank configured to hold a washing liquid;
a washing operation in fluid communication with the tank, wherein the washing operation utilizes the washing liquid;
a filtering assembly positioned between the tank and the washing operation configured to filter particulate matter from the washing liquid;
a supply line connected to the tank and configured to supply fresh water to the tank;
a supply line meter associated with the supply line, the supply line meter configured to measure a volume of water through the supply line to the tank; and
a throughput meter associated with the washing operation, the throughput meter configured to measure a volume of the washing liquid into or out of the washing operation.

2. The system according to claim 1, further comprising
a chemical injection line connected to the tank and configured to supply an antimicrobial solution to the tank; and
a chemical injection line meter associated with the chemical injection line and configured to measure a volume of antimicrobial solution through the chemical injection line to the tank.

3. The system according to claim 1, further comprising
a spray bar line connected to the filtering assembly and configured to provide fresh water to the filtering assembly; and
a spray bar line meter associated with the spray bar line and configured to measure a volume of fresh water through the spray bar line to the filtering assembly.

4. The system according to claim 3, wherein the filtering assembly comprises a rotary screen; and
wherein the spray bar line comprises a spray nozzle positioned to spray the rotary screen with fresh water.

5. The system according to claim 1, further comprising a control unit, wherein the control unit is configured to receive volume data from the supply line meter and the throughput meter.

6. The system according to claim 5, wherein the control unit is further configured to calculate a water savings according to the following formula:
[volume of the washing liquid into or out of the washing operation]−[volume of water through the supply line to the tank].

7. The system according to claim 6, further comprising a display connected to the control unit and configured to display the volume data and/or the water savings.

8. The system according to claim 2, further comprising a control unit, wherein the control unit is configured to receive volume data from the supply line meter, the throughput meter, and the chemical injection line meter.

9. The system according to claim 8, wherein the control unit is further configured to calculate a water savings rate according to the following formula:
[volume of the washing liquid into or out of the washing operation]−[volume of water through the supply line to the tank]−[volume of antimicrobial solution through the chemical injection line to the tank].

10. The system according to claim 3, further comprising a control unit, wherein the control unit is configured to receive volume data from the supply line meter, the throughput meter, and the spray bar line meter.

11. The system according to claim 10, wherein the control unit is further configured to calculate a water savings rate according to the following formula:
[volume of the washing liquid into or out of the washing operation]−[volume of water through the supply line to the tank]−[volume of fresh water through the spray bar line to the filtering assembly].

12. The system according to claim 2, further comprising
a spray bar line connected to the filtering assembly and configured to provide fresh water to the filtering assembly;
a spray bar line meter associated with the spray bar line and configured to measure a volume of fresh water through the spray bar line to the filtering assembly; and
a control unit, wherein the control unit is configured to receive volume data from the supply line meter, the throughput meter, the chemical injection line meter, and the spray bar line meter.

13. The system according to claim 12, wherein the control unit is further configured to calculate a water savings rate according to the following formula:
[volume of the washing liquid into or out of the washing operation]−[volume of water through the supply line to the tank]−[volume of antimicrobial solution through the chemical injection line to the tank]−[volume of fresh water through the spray bar line to the filtering assembly].

14. The system according to claim 1, further comprising
a second washing operation; and
a second throughput meter associated with the second washing operation, the throughput meter configured to measure a volume of the washing liquid into or out of the second washing operation.

15. The system according to claim 1, further comprising an inline filter between the tank and the washing operation.

16. The system according to claim 15, wherein the inline filter comprises one or more bag filters.

17. A method of monitoring a water recycling system, the method comprising:
collecting water usage data, wherein collecting water usage data comprises measuring, with a first set of meters, a washing volume of liquid supplied to a washing operation within the system and measuring, with a second set of meters, a supply volume of liquid introduced into the system;
calculating, using a control unit comprising a microprocessor and in communication with the first and second sets of meters, a water savings by subtracting the supply volume from the washing volume; and
displaying, on a display in communication with the control unit, at least one of the water savings, the supply volume, or the washing volume.

18. The method according to claim 17, further comprising
displaying an alert on the display in response to at least one of the water savings rate, the supply volume, or the washing volume exceeding a predetermined threshold value.

19. The method according to claim 17, further comprising
measuring a liquid level in a tank within the system, wherein at least a portion of the liquid introduced into the system is directed into the tank; and
increasing the supply volume in response to the liquid level falling below a predetermined threshold value.

20. The method of claim 17, further comprising
monitoring a run time of the system;
calculating a water savings volume by multiplying the water savings rate by the run time; and
displaying, on the display, the water savings volume.
